(19) United States
(12) Patent Application Publication
(10) Pub. No.: US 2002/0174902 A1
(43) Pub. Date: Nov. 28, 2002

(54) Cover assembly for fuel tank

(76) Inventors: Sharon Elizabeth Beyer, Grand Blanc, MI (US); Matthew L. Catlin, Flushing, MI (US); Ulf Sawert, Grand Blanc, MI (US); Dale Richard Jones, Flushing, MI (US); Bruce Albert Kuehnemund, Flushing, MI (US); Jeffrey W. Beyer, Grand Blanc, MI (US)

Correspondence Address: VINCENT A. CICHOSZ, DELPHI TECHNOLOGIES, INC., Legal Staff, Mail Code: 480-414-420, P.O. Box 5052, Troy, MI, 48007-5052, US

(21) Appl. No.: 10/011,426

(22) Filed: Nov. 5, 2001

Related U.S. Application Data
(60) Provisional application No. 60/293,661, filed on May 25, 2001.

(51) Int. Cl. F16K 24/00

(52) U.S. Cl. 137/587

(57) ABSTRACT

A cover assembly for a fuel tank of a vehicle includes a cover adapted to close an opening in the fuel tank having a fuel reservoir disposed therein and a carrier disposed within the cover and adapted to allow a plurality of components to be attached thereto.

### CROSS-REFERENCE TO RELATED APPLICATION(S)

The present invention claims the priority date of copending U.S. Provisional Patent Application Serial No. 60/293,661, filed May 25, 2001.

### TECHNICAL FIELD

The present invention relates generally to fuel tanks for vehicles and, more particularly, to a cover assembly for a fuel tank of a vehicle.

### BACKGROUND OF THE INVENTION

It is known to provide a fuel tank in a vehicle to hold fuel to be used by an engine of the vehicle. In such a fuel tank, a fuel delivery module is provided with a cover to seal the opening through which the fuel delivery module has been assembled into the fuel tank. In some cases, the fuel delivery module consists only of a cover/flange to which either an electrical fuel pump and/or a mechanism for indicating fuel is attached. Recently, the trend has been to construct fuel delivery modules with an integral fuel reservoir. Various valves, sensors, pressure regulators, as well as filters have been added over time. Several of these components have been mounted or attached to the cover. Typically, the cover has fuel tubes, an electrical connector, and a rollover valve attached thereto. To attach these components more readily to the cover, the cover is made entirely out of a plastic material.

However, the plastic material has a relatively high permeability when used with fuels. With more stringent government regulations on the permeation of hydrocarbons being implemented, more components are being placed into the fuel tank to reduce the number of openings through a shell of the fuel tank and to minimize hydraulic connections external to the fuel tank. Because of these more stringent government regulations, metal covers/flanges are being specified to reduce the permeation through the material for the cover. Further, as the need for additional features on the metal cover/flange increases, so does the component part count, the number of assembly operations, as well as the cost.

Therefore, it is desirable to provide a cover assembly for a fuel tank that reduces permeation of fuel through the cover. It is also desirable to attach multiple components to a cover of a cover assembly for a fuel tank. It is further desirable to provide a cover assembly for a fuel tank, which reduces the component part count and number of assembly operations. Therefore, there is a need in the art to provide a cover that meets these desires.

### SUMMARY OF THE INVENTION

It is, therefore, one object of the present invention to provide a new cover assembly for a fuel tank of a vehicle.

It is another object of the present invention to provide a cover assembly with a separate cover and a carrier to which multiple components are attached to the cover for a fuel tank.

To achieve the foregoing objects, the present invention is a cover assembly for a fuel tank of a vehicle including a cover adapted to close an opening in the fuel tank having a fuel reservoir disposed therein and a carrier disposed within the cover and connected to the cover to allow a plurality of components to be attached thereto.

One advantage of the present invention is that a new cover assembly is provided for fuel tank of a vehicle that includes a metal cover with a one-piece plastic carrier. Another advantage of the present invention is that the cover assembly has a metal cover and a plastic carrier used in conjunction with the metal cover to minimize permeation and to enhance cover robustness. Yet another advantage of the present invention is that the cover assembly retains the multiple components to the cover via the carrier. Still another advantage of the present invention is that the cover assembly can also be used to retain the electrical connector and the rollover valve. A further advantage of the present invention is that the cover assembly reduces cost by reducing the component part count and number of assembly operations. Yet a further advantage of the present invention is that the cover assembly improves performance by incorporating a plastic carrier into a metal cover, which will allow multiple components to be attached to the cover.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of a cover assembly for a fuel delivery module, according to the present invention, illustrated in operational relationship with a fuel tank.

FIG. 2 is a perspective view of the cover assembly and fuel delivery module of FIG. 1.

FIG. 3 is an exploded perspective view of the cover assembly of FIG. 1.

FIG. 4 is a top perspective view of a carrier of the cover assembly of FIG. 1.

FIG. 5 is a bottom perspective view of the carrier of the cover assembly of FIG. 4.

FIG. 6 is an elevational view of the cover assembly of FIG. 1.

FIG. 7 is a fragmentary top perspective view of a portion of the cover assembly of FIG. 1.

FIG. 8 is a bottom perspective view of the portion of the cover assembly of FIG. 7.

FIG. 9 is a fragmentary elevational view of the cover assembly of FIG. 1.

### DESCRIPTION OF THE PREFERRED EMBODIMENT

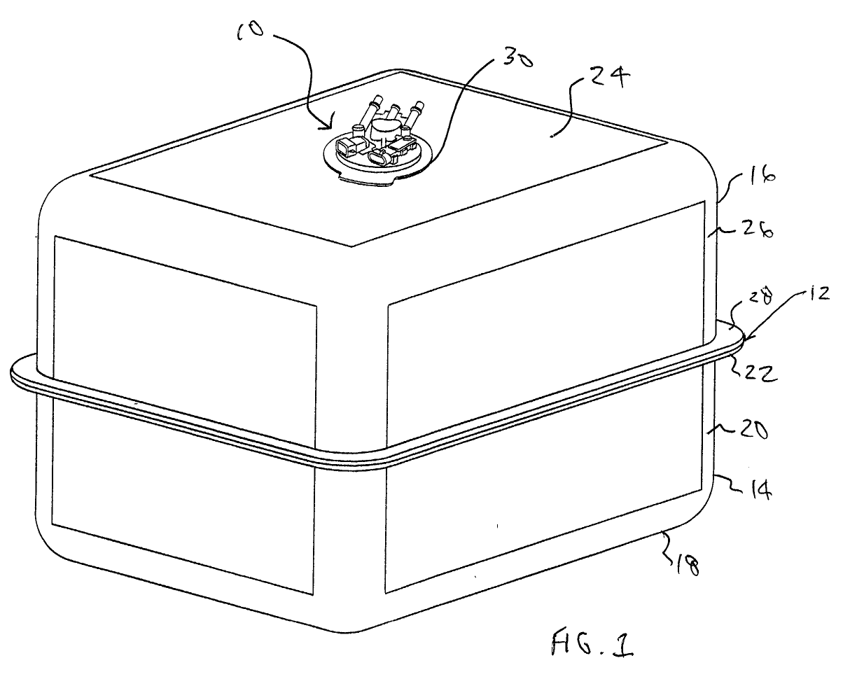

Referring to the drawings and in particular FIGS. 1 through 3, one embodiment of a cover assembly 10, according to the present invention, is shown for a fuel tank 12 of a vehicle (not shown). The fuel tank 12 includes a first or lower half shell 14 and a second or upper half shell 16. The lower half shell 14 has a base wall 18 and a side wall 20 around a periphery of the base wall 18 and extending generally perpendicular thereto. The side wall 20 has a flange 22 extending outwardly and generally perpendicular thereto. The upper half shell 16 has a base wall 24 and a side wall 26 around a periphery of the base wall 24 and extending generally perpendicular thereto. The side wall 26 has a flange 28 extending outwardly and generally perpendicular thereto. The flanges 22 and 28 of the lower half shell 14 and upper half shell 16, respectively, are joined together by suitable means such as by welding. The lower half shell 14 and upper half shell 16 are made of a rigid material such as plastic. The base wall 24 of the upper half shell 16 includes an opening 30 for the cover assembly 10. It should be appreciated that, except for the cover assembly 10, the fuel tank 12 is conventional and known in the art.

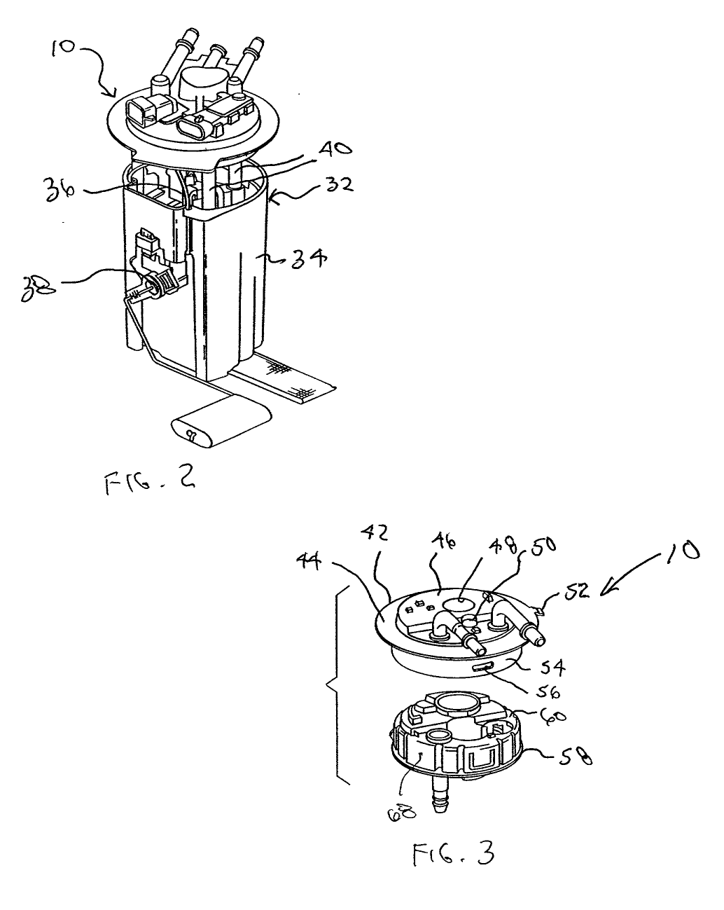

As illustrated in FIG. 2, the cover assembly 10 is part of a fuel delivery module, generally indicated at 32. The fuel delivery module 32 is disposed in the fuel tank 12 to deliver fuel from the fuel tank 12 to an engine (not shown) of the vehicle. The fuel delivery module 32 includes a reservoir assembly 34 having an electrical fuel pump 36 mounted therein. The fuel delivery module 32 also includes a fuel level indication mechanism 38 such as a rheostat connected to the reservoir assembly 34 for indicating the level of the fuel inside the fuel tank 12. The fuel delivery module 32 further includes a plurality of guide rods or tubes 40 to mechanically connect the cover assembly 10 with the reservoir assembly 34. It should be appreciated that, in other types of fuel delivery modules, there is no mechanical connection between the cover assembly 10 and the reservoir assembly 34 and this type of module requires a retaining mechanism on the bottom of the fuel tank 12.

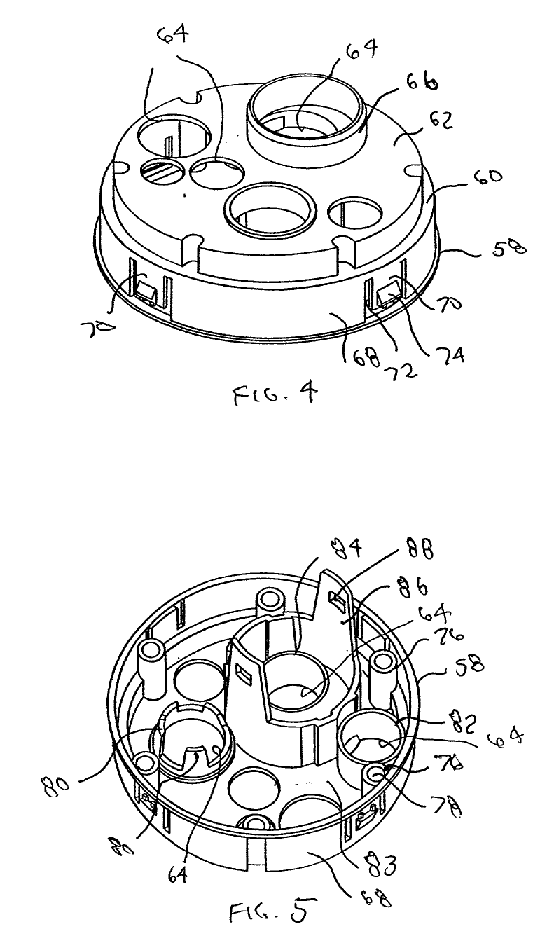

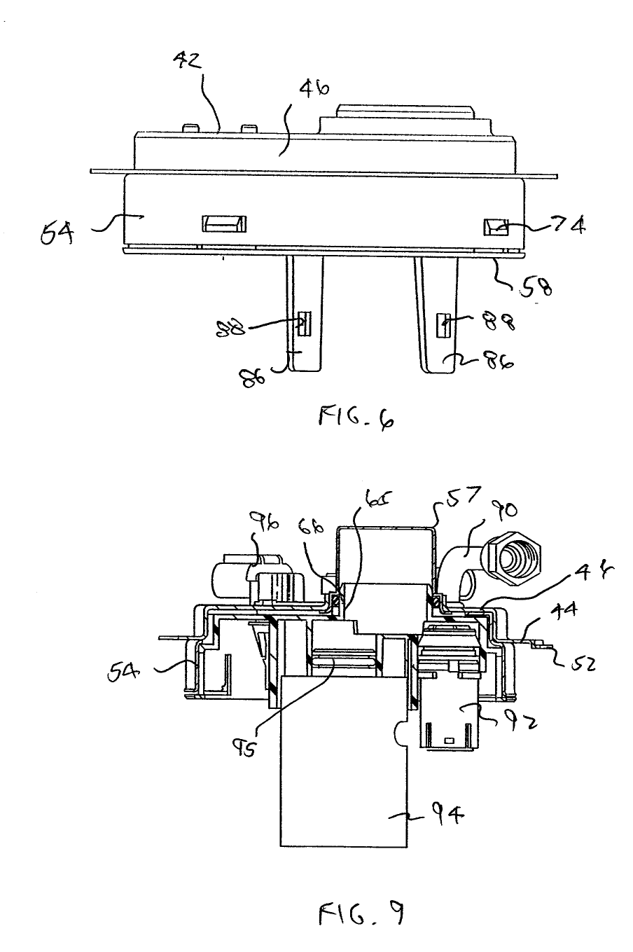

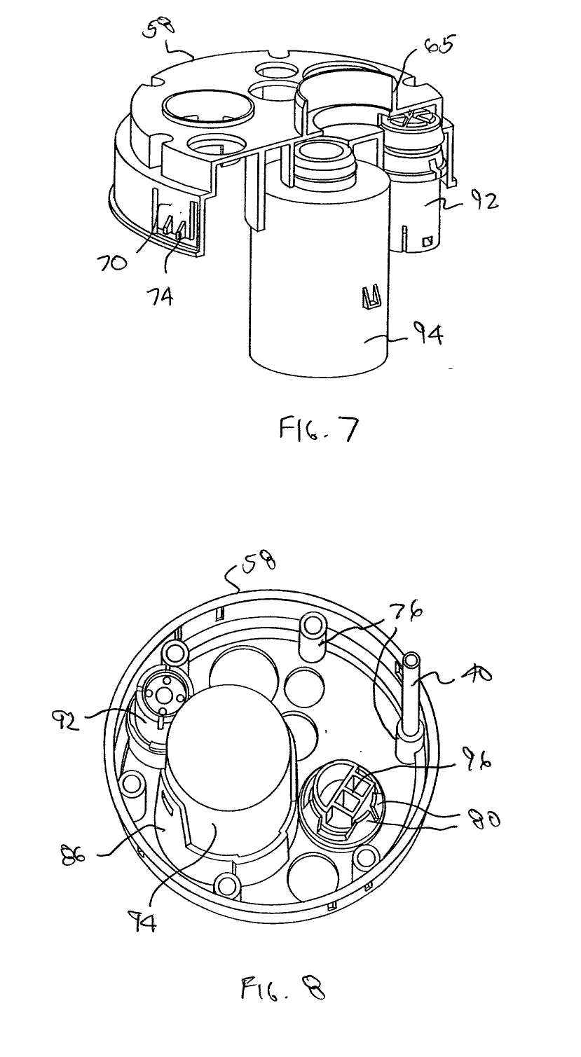

Referring to FIGS. 3 through 9, the cover assembly 10 includes a cover 42 to cover or close the opening 30. The cover 42 is generally circular in shape. The cover 42 includes a base wall 44 having a raised portion 46. The raised portion 46 has at least one, preferably a plurality of apertures 48,50 extending therethrough for a function to be described. The cover 42 also includes a flange wall 52 extending downwardly and radially outwardly from the base wall 44. The cover 42 further includes a skirt or side wall 54 extending generally perpendicular and axially from the base wall 44. The skirt 54 may include one or more apertures or windows 56 extending therethrough for a function to be described. The cover 42 may include a dome 57 (FIG. 9) having a generally circular shape and extending axially from the raised portion 46. The cover 42 is made from a metal material such as steel, which is conventional and known in the art.

The cover assembly 10 also includes an adapter or carrier 58 disposed within and molded to the cover 42. The carrier 58 is generally circular in shape. The carrier 58 has a base wall 60 that is generally planar and circular in shape. The base wall 60 has a raised portion 62 with at least one, preferably a plurality of apertures 64 extending therethrough for a function to be described. The raised portion 62 also has a step 66 that is generally circular in shape and extending axially to provide a support surface for an o-ring 67 used to seal the carrier 58 to the cover 42 at the base of the dome 57. The base wall 60 is disposed adjacent the base wall 44 of the cover 42. The carrier 58 also includes a side wall 68 extending generally perpendicular from the base wall 60. The side wall 68 also includes at least one, preferably a plurality of retaining tabs or snaps 70 for retention of the carrier 58 to the cover 42. The retaining snaps 70 are formed by a generally “U” shaped slot 72 in the side wall 68 and are deflectable. Each of the retaining snaps 70 have a projection 74 extending radially to be disposed in the apertures 56 in the skirt 54 of the cover 42. The side wall 68 is disposed adjacent the skirt 54 of the cover 42. It should be appreciated that the carrier 58 is attached to the cover 42 by latching a plurality of the retaining snaps 70 into an equivalent number of apertures 56 in the skirt 54 of the cover 42.

The carrier 58 includes at least one, preferably a plurality of guide rod retaining bosses 76. The guide rod retaining bosses 76 are generally cylindrical and circular in shape. The guide rod retaining bosses 76 have a cavity 78 extending axially therein to receive and retain the guide rods 40. The guide rod retaining bosses 76 extend axially from the base wall 60 and raised portion 62 and may extend radially from the side wall 68 of the carrier 58. It should be appreciated that the guide rod retaining bosses 76 provide rotational flexibility in the attachment of the cover assembly 10 with the reservoir assembly 34.

The carrier 58 may include at least one, preferably a plurality of retaining tabs 80 disposed about at least one of the apertures 64 and extend axially for a function to be described. The carrier 58 also includes a first cylindrical wall 82 extending axially from an interior surface 83 of the raised portion 62 for a function to be described. The carrier 58 also includes a second cylindrical wall 84 extending axially from the interior surface 83 of the raised portion 62. The carrier 58 further includes at least one, preferably a plurality of retention tabs 86 with each having an aperture or window 88 extending therethrough. The retention tabs 86 are disposed about at least one of the apertures 64 and extend axially for a function to be described. The carrier 58 is made from a plastic material such as a polyethylene. It should be appreciated that the carrier 58 is a monolithic structure being integral, unitary, and one-piece.

The cover assembly 10 may include at least one, preferably a plurality of fuel tubes 90 extending into and through the apertures 50 of the cover 42. The fuel tubes 90 are connected or assembled to the cover 42 by suitable means such as brazing, soldering, welding, or mechanical retention. The cover assembly 10 may include a rollover vent valve 92 extending into the aperture 64 surrounded by the first cylindrical wall 82 of the carrier 58. The first cylindrical wall 82 provides sealing and retention for the rollover vent valve 92. The cover assembly 10 may include a fill limiting vent valve 94 extending into the aperture 64 surrounded by the second cylindrical wall 84 of the carrier 58. The second cylindrical wall 84 provides sealing for an o-ring 95 attached to the fill limiting vent valve 94. The retention tabs 86 provide mechanical retention of the fill limiting vent valve 94 when snaps of the fill limiting vent valve 94 latch into the apertures 88. The cover assembly 10 may include an electrical connector 96 extending into and through the aperture 48 of the cover 42 and the aperture 64 surrounded by the retaining tabs 80 of the carrier 58. The retaining tabs 80 provide retention for the electrical connector 96. It should be appreciated that the valves 92 and 94 operate in series to accurately control the fill of the fuel tank 12. It should also be appreciated that the valves 92 and 94 vent to a charcoal canister (not shown) through a common vent tube (not shown) and communicate with the dome 57 and its associated vent tube through the cavity 65 in the carrier 58 with which both valves 92 and 94 are in communication. It should also be appreciated that the fuel tubes 90, rollover vent valve 92, fill limiting vent valve 94, and electrical connector 96 are conventional and known in the art. It should further be appreciated that the carrier 58 may be extended to other components such as pressure regulators, pressure relief valves, etc.

The carrier 58, when molded from a conductive polymer with a resistance of less than 10¹⁰ ohms can provide dissipation of electrical charges, which may build up in conductive components due to charges resulting from the flow of fuel under some conditions. It should be appreciated that, by tying various components such as guide rods and regulators together, and by being in contact with the metal cover 42, which is normally grounded to the vehicle chassis, the carrier 58 provides an effective and economical mechanism of providing charge dissipation.

In assembling the cover assembly 10, the carrier 58 is snap-fitted to the cover 42. The fuel tubes 90, rollover vent valve 92, fill limiting vent valve 94, and electrical connector 96 are assembled to the carrier 58. The cover 42 cover is placed over the opening 30 and secured to the base wall 24 of the upper half shell 16 by an interlayer (not shown) of plastic material forming a weld therebetween. It should be appreciated that the process of securing the metal cover 42 to the plastic base wall 24 is conventional and known in the art.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A cover assembly for a fuel tank of a vehicle comprising:
a cover adapted to close an opening in the fuel tank having a fuel reservoir disposed therein; and
a carrier disposed within said cover and adapted to allow a plurality of components to be attached thereto.

2. A cover assembly as set forth in claim 1 wherein said cover is made of a metal material.

3. A cover assembly as set forth in claim 1 wherein said carrier is made of a plastic material.

4. A cover assembly as set forth in claim 1 wherein said carrier has a base wall and a side wall extending from said base wall.

5. A cover assembly as set forth in claim 4 wherein said carrier include s at least one guide rod retaining boss connected to at least one of said base wall and said side wall and having a cavity therein to receive a guide rod of the fuel reservoir.

6. A cover assembly as set forth in claim 4 wherein said base wall has a plurality of apertures extending therethrough.

7. A cover assembly as set forth in claim 6 including a fuel limiting vent valve extending into said carrier and communicating with at least one of said apertures.

8. A cover assembly as set forth in claim 6 including a rollover vent valve extending into said carrier and communicating with at least one of said apertures.

9. A cover assembly as set forth in claim 6 including an electrical connector extending into and communicating with at least one of said apertures.

10. A cover assembly as set forth in claim 6 including a fuel tube extending into and communicating with at least one of said apertures.

11. A cover assembly as set forth in claim 1 wherein said carrier is snap-fitted to said cover.

12. A cover assembly for a fuel tank of a vehicle comprising:
a metal cover adapted to close an opening in the fuel tank having a fuel reservoir disposed therein; and
a plastic carrier disposed within said cover and adapted to allow a plurality of components to be attached thereto.

13. A cover assembly as set forth in claim 12 wherein said carrier has a base wall and a side wall extending from said base wall.

14. A cover assembly as set forth in claim 13 wherein said carrier includes at least one guide rod retaining boss connected to at least one of said base wall and said side wall and having a cavity therein to receive a guide rod of the fuel reservoir.

15. A cover assembly as set forth in claim 13 wherein said base wall has a plurality of apertures extending therethrough.

16. A cover assembly as set forth in claim 15 including a fuel limiting vent valve extending into said carrier and communicating with at least one of said apertures.

17. A cover assembly as set forth in claim 15 including a rollover vent valve extending into said carrier and communicating with at least one of said apertures.

18. A cover assembly as set forth in claim 15 including an electrical connector extending into and communicating with at least one of said apertures.

19. A cover assembly as set forth in claim 12 wherein said carrier is snap-fitted to said cover.

20. A fuel tank for a vehicle comprising:
a fuel tank having an opening formed in a wall thereof;
a fuel reservoir disposed through said opening and into said fuel tank;
a cover assembly operatively connected to said fuel reservoir to close said opening; and
wherein said cover assembly comprises a metal cover and a plastic carrier disposed within said cover and adapted to allow a plurality of components to be attached thereto.
